(19) United States
(12) Patent Application Publication
(10) Pub. No.: US 2006/0210024 A1
(43) Pub. Date: Sep. 21, 2006

(54) Method of screening calls and communication device having the call screening function

(76) Inventor: Chenxia Qiu, Wellington, FL (US)

Correspondence Address: LERNER GREENBERG STEMER LLP, P O BOX 2480, HOLLYWOOD, FL, 33022-2480, US

(21) Appl. No.: 11/085,718

(22) Filed: Mar. 21, 2005

(51) Int. Cl. H04M 1/64

(52) U.S. Cl. 379/88.01; 379/188

(57) ABSTRACT

A method for screening incoming calls includes programming a phone with a call screening function, and activating the call screening function on the phone for screening all incoming calls which results in automatic deactivation of a phone ringer. Upon receiving an incoming phone call, a message is transmitted to the incoming caller that the called party is unavailable and in addition rules for overriding the call screening function so that the incoming caller can initiate steps for overriding the call screening function are also transmitted.

### BACKGROUND OF THE INVENTION

### Field of the Invention

The invention relates, generally, to a method of blocking some communications, such as incoming calls, for a given time period and at the same time letting other communications proceed. The invention further relates to a communications device having such a call screening function.

U.S. Pat. No. 5,467,388 to Redd, Jr. et al. describes a system for allowing a telephone subscriber to selectively block incoming calls for selected periods of time or during a programmed interval. A subscriber may pre-program a time interval in minutes or a time period (start time and end time) for which some incoming calls are to be blocked. The subscriber assigns caller numbers or personal identification numbers to one of a plurality of tiers of access. The subscriber may enable the call blocking system for selected access tiers. An emergency access tier may be provided to insure emergency calls are not blocked by the system. The service may be activated or deactivated by a call from the subscriber to a system number followed by an appropriate identification period and tier access codes. The service is provided by a centralized system but not in the communications device itself and requires the user to input the phone numbers for the various tiers of callers.

U.S. Pat. No. 6,160,877 to Tatchell et al. teaches another centralized system for screening and prioritizing incoming calls. In Tatchell, the critical or prioritized numbers are input by the user to the centralized system. As in Redd, Jr. the communications device itself does not provide the service.

U.S. Pat. No. 6,253,075 to Beghtol et al. teaches a method and apparatus for rejecting incoming calls for use in a mobile communications device. The method and apparatus permit a user of a mobile communications device to automatically reject calls intended to be received by the device. A rejection memory within the mobile device is preprogrammed with identification information representative of transmitting stations to be rejected.

When a call is incoming, identification information included with the incoming call is compared with identification information contained in the rejection memory. When a match is detected, a rejection message is automatically sent to the mobile communications device to the transmitting station. Upon receipt of the rejection message, the transmitting station terminates the call and may reroute the call to a voice messaging system. As in the other described patents, Beghtol requires the manual inputting of data for selecting the rejected transmitting stations.

One simple solution to preventing a cell phone interruption during a critical time period such as a business meeting, is to power off or mute the cell phone. However, the ability to allow through a critical call through cannot occur.

### SUMMARY OF THE INVENTION

It is accordingly an object of the invention to provide a method of screening calls and a communication device having the call screening function which overcome the herein-mentioned disadvantages of the heretofore-known devices and methods of this general type, which is easy to implement and is provided in the communications device itself without the need of a centralized service provider.

With the foregoing and other objects in view there is provided, in accordance with the invention, a method for screening incoming calls. First, a call screening function is activated on a phone for screening all incoming calls which results in automatic deactivation of a phone ringer. Upon receiving a phone call from an incoming caller, a phone number of the incoming caller is assigned an identification code; and a message is transmitted to the incoming caller that a called party is unavailable.

It is an object of the invention to incorporate a call screening function into a standard communications device in a simple and easy manner. The call screening function will allow people facing different scenarios such as meetings, movies, religious services, napping, etc. to program their devices to screen incoming calls and to prevent the connection of trivial calls but to allow critical calls to connect through. The ability to connect through is given to the caller rather than being provided by the owner of the phone.

In accordance with an added mode of the invention, a further message is transmitted that identifies how to bypass the call screening function and allows the incoming caller to leave a message. In addition the further message can contain information that the called party will continue to be unavailable for a given time period and why the called party is unavailable.

In accordance with a further feature of the invention, the identification code is assigned a number count reflecting the number of times the phone number with the identification code has called the called party. The number count is then compared with a given threshold, and the phone ringer is activated to allow the phone call of the incoming caller through if the given threshold is met.

In accordance with an additional feature of the invention, the identification code is assigned a time stamp indicating a time of the phone call, and the time stamp is compared with the actual time for determining if the time stamp is within a given duration. The identification code is deleted if the given duration is exceeded. The time stamp can be reviewed periodically for expiration or only upon the receipt of another incoming call.

Other characteristic features of the invention are set forth in the appended claims.

Although the invention is illustrated and described herein as embodied in a method of screening calls and a communication device having the call screening function, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flow chart for describing the initialization of a call screening function according to the invention;

FIG. 2 is an illustration showing how incoming calls are recorded; and

FIGS. 3-5 are flow charts illustrating two variants of the implementation of the invention.

### DESCRIPTION OF THE PREFERRED EMBODIMENTS

An overall concept of the invention is to allow the caller to decide whether to interrupt a called party. The invention relates to adding a new function into existing communication devices such as cell phones. More specifically, the invention relates to implementing a call screening function or service using existing common devices. The call screening service of the invention does not require the services of a call center or require the complicated inputting of numbers to be screened or let through. In addition, the invention can be implemented in a hardware fashion, if desired.

A user who initiates the call screening function has the ability to screen out all calls and in addition has the ability to allow callers to override the call screening function so as to allow critical calls to go through. Once activated, the call screening function will not activate the phone ringer unless the incoming caller has met or performs a predetermined number of steps to override the call screening function. Therefore, if the phone rings the user knows that it is a critical call or at least that the caller has gone through an exercise of steps to be allowed through.

During operation of the call screening function, all incoming calls are immediately screened and a message mode service is activated to allow the caller the opportunity to leave a message. In addition, the message mode service can provide the caller with situational information such as a message indicating that the owner will be in a meeting, for example until 2:00 p.m., and to please not interrupt unless the call is critical.

However, one can also provide the caller with the necessary information to bypass the call screening function. After a caller has received a message that the user is in a specific situation such as a meeting and the importance of the meeting, one can receive bypass access rules to allow the eventual forwarding of the call. The bypass rules may be set in a number of ways. One option relates to recording the number of times a caller has attempted to call in a given duration. Once that threshold number of calls has been reached the call is automatically forwarded. For example, the message is forwarded on the third call attempt in any given five-minute period.

The call screening function can be set for a given duration where the screening function will automatically lapse upon expiration of the given duration. Alternatively, one can simply cancel the call screening function upon submitting a cancellation request. The call screening function upon activation is set for a given duration entered by the user or in the alternative if no time entry is provided an automatic default period is entered (e.g. 1 hour) and the reason why the caller is not available is given.

To implement the call screening function three conditions must be met. First, the call screening function must be made available in the receiving communications device. Second, the call screening function must be activated, and third, all callers must follow some common rules. Once the call screening function is enabled, all incoming calls will be screened and the ringer will not activate. Instead, the communications device (e.g. phone) will send a short message, for example voice or text. The message will inform the caller that the person he/she wants to contact is unavailable. As noted above, the message may contain specific information regarding the unavailability such as “meeting in progress call back later” or “meeting in progress call back in T minutes”; where T is the time left for the duration of the unavailability.

In addition to sending the above message an additional message may be sent “if this call is important please call back N more times in the next T minutes to gain access to the called person”. The call screening function records the phone numbers of incoming calls and starts a timer for counting a predetermined time duration for each incoming phone number of a caller. During the predetermined time duration the call screening function records how many times the caller attempted to call. Each phone number is assigned an ID (e.g. the phone number is recorded) and the duration period and number of calls received may be tailored per the selection of the user. Once a predetermined number of calls have occurred in a given duration the call is forwarded through and is no longer screened. For example, once the call counter increases to some number, for example three from the same phone number (e.g. caller), before the time duration expires, the phone ringer is activated and the call is put through.

Whenever the predetermined time duration expires, the call screening function will delete all records relating to that specific caller as the caller has not called enough times within a selected time duration and the call will be determined to be not critical.

It should be noted that the calling screen function works with wired phones, wireless phones, cell phones and other communication devices.

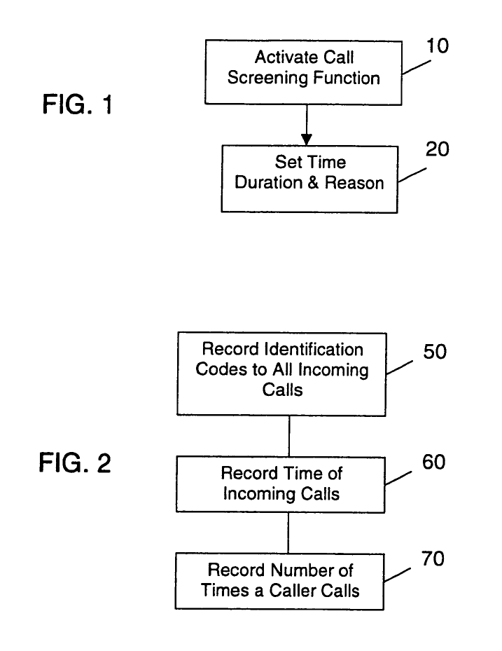

FIG. 1 shows steps for initiating the call screening function. In step 10, the call screening function is activated. After activation, a start time and an end time for the meeting mode are set, step 20. The user enters the necessary information and the call screening function is then activated for the entered duration. If no time is entered a default period automatically starts. Once the call screening function is selected, the message given to all incoming callers tells them how long the called person will be unavailable and whether a bypass function is available and an explanation on how to activate the pass mode. In addition to how much time, it can simply be stated that the called person is unavailable till a designated time. Furthermore, the reason for the call blocking function may also be entered (e.g. in a meeting, not available, etc.). If no entry is made a default message may be entered.

As shown in FIG. 2, all phone numbers of incoming calls will be used as an identification code (ID), step 50, and the time of the call is recorded, step 60. Then the number of times an identified caller has called is also recorded, step 70.

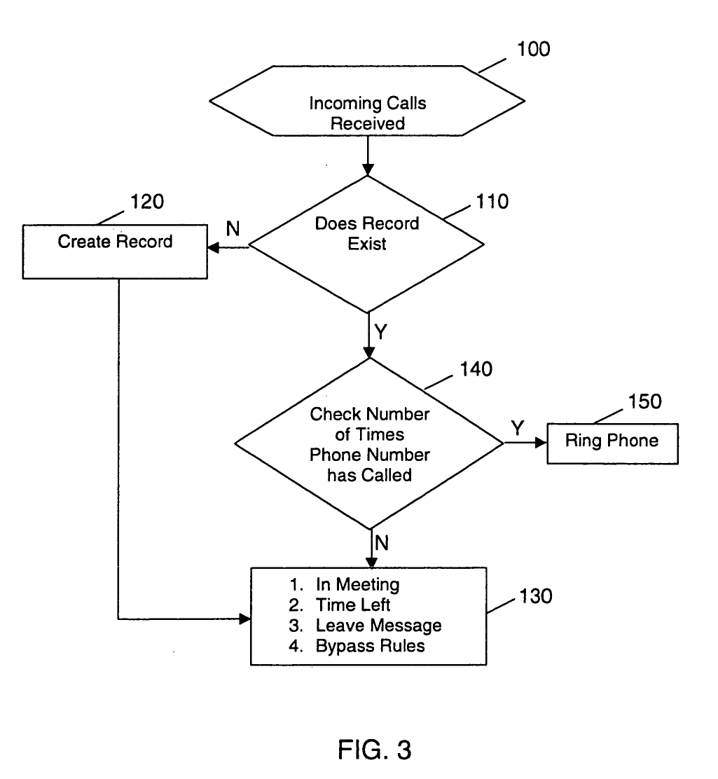

More specifically, FIG. 3 shows how a call is processed. In step 100, an incoming call is received and then in step 110 it is determined if the calling number has been recorded. If the answer is no, a record related to the calling number is created, step 120. Then in step 130 a message is delivered identifying the reason for the call screening function and a time related message. At this time, the caller is prompted to leave a message. In addition or alternatively, a bypass rules message may be delivered or alternatively the bypass rules are provided in an instruction manual sold with the communication device. Should it be determined that an incoming caller record exits, the number of times that phone number or ID has called is incremented and compared to a given threshold, step 140. Should the threshold not be met, the caller receives the messages shown in step 130. On the other hand, should the threshold be exceeded, the call is forwarded and the ringer is activated in the communications device, step 150.

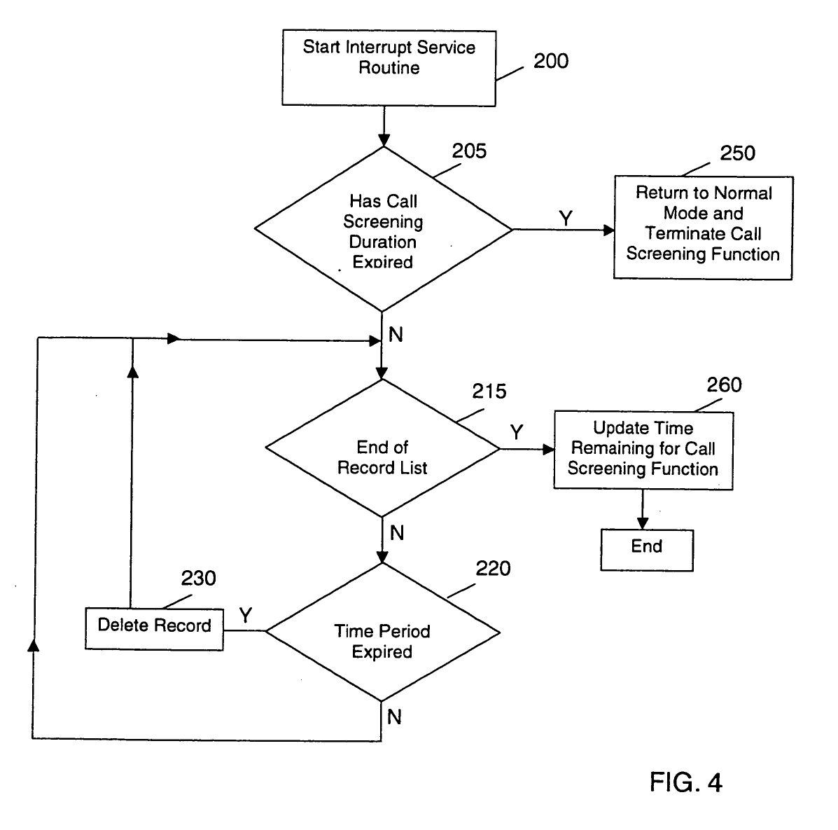

FIG. 4 is a flow chart illustrating an implementation of the time recordation function to be used in conjunction with the embodiment shown in FIG. 3. More specifically, FIG. 4 illustrates a timer interrupt service routine in which a timer initiates periodic interrogations. In step 200, the interrupt service routine is started. In step 205, it is checked whether the call screening duration has expired. If the duration has expired the call screening function is terminated, step 250. If not, the record list of phone calls is reviewed. In step 215, it is checked whether we are at the end of the record list. If we are at the end of the record list, the time left in the call screening function is updated, step 260. If we are not at the end of the record list, it is determined whether the initial time period related to a time stamp of a respective record has expired, step 220. If the time period has expired, the record is deleted from the record list, step 230. If the time period has not expired, the next record in the record list is reviewed. The record list will be fully reviewed once per given interval initiated by a timer. In FIG. 4, all entries are checked on a periodic basis. Of course many other methods are possible for performing this feature and this method is merely exemplary.

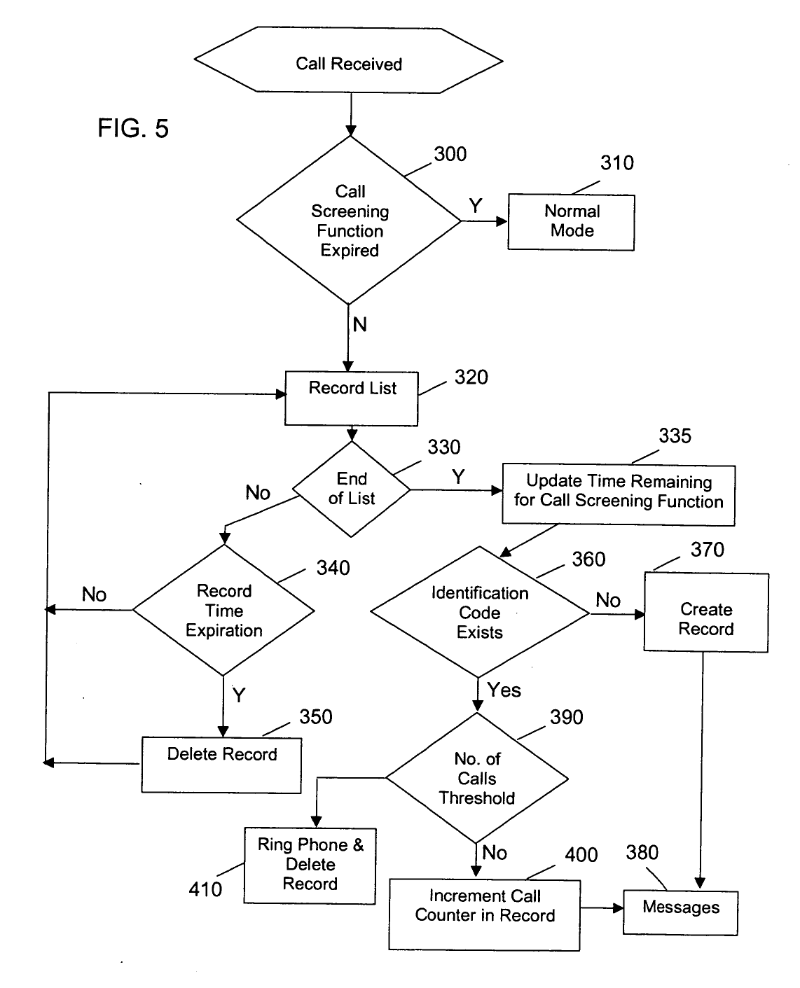

FIG. 5 shows a call driven scenario where the record list entries are not checked on a periodic basis as shown in FIG. 4. Rather, the record list entries are only checked upon receiving a call. Upon receiving the incoming call, it is checked if the call screening function has expired, step 300. If the time for the-call screening function has expired, the call screening function is terminated and the normal mode is activated and the phone rings, step 310. If the call screening function is still active, a record list review is activated, step 320. The records are checked to determine if we are at the end of the list, step 330. If we not at the end of the list, the record list entries are cycled for testing. All time stamps are checked for time expiration for each record list entry, step 340. If time has expired, the record list entry is deleted, step 350. If the time has not expired, the next entry is reviewed.

In step 330, if we reach the end of the list, the time remaining in the call screening function is updated. In step 360, it is determined if an identification code corresponding to the incoming call exists (e.g. has the phone number been recorded). If no identification code exists, a record is generated in step 370. A message is then generated informing the caller of the call screening mode, the time left, leave message option, and optionally information regarding the bypass function in step 380. If the identification code exists, a test is performed as to how many times the phone number has called in step 390. If the number of times does not exceed a predetermined threshold, the number of times (e.g. counter) is incremented by one in step 400. The call is then forwarded for the messages in step 380. If the number of times of attempted calls for a given identification code (phone number) exceeds the predetermined threshold, the phone ringer is activated and the record is deleted in step 410.

We claim:

1. A method for screening incoming calls, which comprises the steps of:
activating a call screening function on a phone for screening all incoming calls which results in automatic deactivation of a phone ringer;
receiving a phone call from an incoming caller;
assigning a phone number of the incoming caller with an identification code; and
transmitting a message to the incoming caller that a called party is unavailable.

2. The method according to claim 1, which further comprises transmitting a further message that identifies how to bypass the call screening function.

3. The method according to claim 1, which further comprises allowing the incoming caller to leave a message.

4. The method according to claim 1, which further comprises:
assigning the identification code a number count reflecting a number of times the phone number with the identification code has called the called party;
comparing the number count with a given threshold; and
activating the phone ringer and allowing the phone call of the incoming caller through if the given threshold is met.

5. The method according to claim 4, which further comprises:
assigning the identification code a time stamp indicating a time of the phone call; and
comparing the time stamp with actual time for determining if the time stamp is within a given duration before performing the step of comparing the number count with the given threshold; and
deleting the identification code if the given duration is exceeded.

6. The method according to claim 5, which further comprises periodically reviewing the time stamp for expiration.

7. The method according to claim 5, which further comprises reviewing the time stamp for expiration again only upon receiving a next phone call.

8. The method according to claim 5, which further comprises checking to see if the phone number has been previously assigned an identification code.

9. The method according to claim 4, which further comprises incrementing the number count each time the phone number with the identification code calls the called party.

10. The method according to claim 5, which further comprises incrementing the number count each time the phone number with the identification code calls the called party.

11. The method according to claim 1, which further comprises transmitting a further message that the called party will continue to be unavailable for a given time period.

12. A method for screening incoming calls, which comprises the steps of:
programming a phone with a call screening function;
activating the call screening function on the phone for screening all incoming calls which results in automatic deactivation of a phone ringer;
receiving a phone call from an incoming caller; and
transmitting a message to the incoming caller that a called party is unavailable and rules for overriding the call screening function so that the incoming caller can initiate steps for overriding the call screening function.

13. A communications device, comprising:
a phone ringer; and
a processor coupled to said phone ringer and programmed with a call screening function to screen all incoming calls for determining if the call should be allowed through, said processor activating said phone ringer if the call should be allowed through.

14. The communications device according to claim 13, wherein said call screening function is further programmed to:
activate upon entry of a call screening function activation request resulting in the screening of all the incoming calls and automatic deactivation of said phone ringer;
transmit a message to an incoming caller that a called party is unavailable and rules for overriding the call screening function so that the incoming caller can initiate steps for overriding the call screening function.

15. The communications device according to claim 14, wherein said call screening function is further programmed to:
assign a phone number of the incoming caller with an identification code;
assign the identification code a number count reflecting a number of times the phone number with the identification code has called the called party;
compare the number count with a given threshold; and
activate said phone ringer and allowing the phone call of the incoming caller through if the given threshold is met.

16. The communications device according to claim 15, wherein said call screening function is additionally programmed to:
assign the identification code a time stamp indicating a time of the phone call;
compare the time stamp with actual time for determining if the time stamp is within a given duration before performing the step of comparing the number count with the given threshold; and
delete the identification code if the given duration is exceeded.

17. The communications device according to claim 13, wherein the communications device is selected from the group consisting of a land line phone, a mobile phone, and a hand held computation device.
